(19) United States
(12) Patent Application Publication
(10) Pub. No.: US 2025/0380088 A1
(43) Pub. Date: Dec. 11, 2025

(54) Speaker

(71) Applicant: AAC Microtech (Changzhou) Co., Ltd., Changzhou City (CN)

(72) Inventors: Zhiwei Zhong, Changzhou (CN); Bo Xiao, Changzhou (CN)

(21) Appl. No.: 18/983,277

(22) Filed: Dec. 16, 2024

Related U.S. Application Data
(63) Continuation of application No. PCT/CN2024/098013, filed on Jun. 7, 2024.

(51) Int. Cl. H04R 7/18; H04R 1/02; H04R 7/04; H04R 9/02; H04R 9/04; H04R 9/06

(52) U.S. Cl. CPC H04R 7/18; H04R 1/023; H04R 7/04; H04R 9/025; H04R 9/045; H04R 9/06; H04R 2400/11

(57) ABSTRACT

The present invention provides a speaker including a frame, a vibration system, and a magnetic circuit system. The vibration system includes a diaphragm, a voice coil, and a supporting member. The diaphragm includes a first suspension, a second suspension, and a dome. The dome includes a main portion, a first extension portion bending and extending from an inner periphery of the main portion in a direction close to the supporting member, and a second extension portion bending and extending from the first extension portion in the direction close to the first suspension. An outer periphery of the main portion and the second extension portion are fixed to the supporting member, and the outer periphery of the first suspension is fixed to the second extension portion. The speaker of the present invention has a better reliability and a higher stability of acoustic performance.

### FIELD OF THE PRESENT INVENTION

The present invention relates to the field of acoustic-electro conversion, and more particularly, to a speaker.

### DESCRIPTION OF RELATED ART

With the development of science and technology, portable electronic products such as mobile phones, handheld game consoles, navigation devices, and handheld multimedia entertainment devices are widely used in people's daily lives. Among these mobile electronic devices, voice playback devices are essential components, and the quality of voice directly affects the user's experience when using these mobile electronic devices. Therefore, the requirements for speakers used in these mobile electronic devices are becoming increasingly high.

In related art, the speaker includes a frame, a vibration system fixed to the frame, and a magnetic circuit system. The magnetic circuit system has a magnetic gap. The vibration system includes a diaphragm fixed to the frame, a voice coil driving the diaphragm to vibrate and generate sounds, and a support connecting the diaphragm and voice coil. However, in related art, the dome or the support is usually a planar structure, and only one end of the dome is fixedly connected to the support. The strength and reliability of this dome or support of this speaker are not high, which can affect the acoustic performance of the speaker.

Therefore, it is desired to provide a new speaker which can overcome the above problems.

### SUMMARY

In view of the above, the embodiments of the present invention provide a new speaker with better reliability and higher acoustic performance stability.

The present invention provides a speaker including a frame, a vibration system mounted with the frame, and a magnetic circuit system mounted with the frame. The vibration system includes a diaphragm fixed on the frame, a voice coil driving the diaphragm to generate sounds, and a supporting member connecting the diaphragm and the voice coil. The diaphragm includes a first suspension, a second suspension arranged out of the first suspension, and a dome located between the first suspension and second suspension. The dome includes a main portion, a first extension portion bending and extending from an inner periphery of the main portion in a direction close to the supporting member, and a second extension portion bending and extending from the first extension portion in the direction close to the first suspension. An outer periphery of the main portion and the second extension portion are fixed to the supporting member, and the outer periphery of the first suspension is fixed to the second extension portion.

As an improvement, the second extension portion includes a first surface facing to the supporting member and a second surface opposite to the first surface, the first surface fixed with the supporting member by glue, and second surface fixed with the first suspension by glue.

As an improvement, the first suspension includes a first bending portion, a first outer fixing portion bending and extending from the outer periphery of the first bending portion, and a first inner fixing portion bending and extending from the inner periphery of the first bending portion, the first outer fixing portion fixedly connected to the second extension portion, the first outer fixing portion closer to the supporting member than the first inner fixing portion in a vibration direction of the diaphragm.

As an improvement, the supporting member includes a first part fixedly connected to the main portion, a second part bending and extending from the inner periphery of the first part along the direction away from the diaphragm, and a third part bending and extending from the second part along the direction close to the first suspension, the third part fixedly connected to the second extension portion.

As an improvement, the third part includes a first section connected to the second part and a second section bending and extending from the inner periphery of the first section in the direction close to the dome, the second section fixedly connected to the second extension portion.

As an improvement, the supporting member includes a pair of long axis sides arranged facing to each other, a pair of short axis sides arranged facing to each other, and four corner portions connecting the long axis sides and the short axis sides, the supporting member further including a plurality of support portions extending from each corner portion in the direction close to the voice coil, the voice coil fixed to the support portions, a plurality of spacers provided sandwiched between the support portions and the voice coil.

As an improvement, the second suspension includes a second bending portion, a second outer fixing portion extending from the outer periphery of the second bending portion, and a second inner fixing portion extending from the inner periphery of the second bending portion, the second outer fixing portion fixedly connected to the frame, and the second inner fixing portion fixedly connected to at least one of the first part and the main portion.

As an improvement, the magnetic circuit system includes a lower plate fixed to the frame, a main magnetic assembly fixed to an upper surface of the lower plate, and an auxiliary magnetic assembly arranged around the main magnetic assembly, the main magnetic assembly spaced apart from the auxiliary magnetic assembly to form a magnetic gap.

As an improvement, the speaker further includes a cover portion covered above the magnetic circuit system, the cover portion including a top wall, a side wall extending from the top wall along the direction close to the lower plate, and a bottom wall bending and extending from the side wall along the direction close to the first suspension and fixed to the auxiliary magnetic assembly, the top wall attached to the main magnetic assembly.

As an improvement, the speaker further includes a metal ring arranged around the magnetic circuit system, the metal ring including a first ring portion fixedly connected to the bottom wall and a second ring portion bending and extending from the outer periphery of the first ring portion along the direction close to the first suspension, the second ring portion fixedly connected to the first inner fixing portion.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a speaker of the present invention.

FIG. 2 is an exploded view of the speaker of FIG. 1.

FIG. 3 is an illustrative cross-sectional view of the speaker taken along line A-A of FIG. 1.

FIG. 4 is an enlarged partial view of part B in FIG. 3;

FIG. 5 is an illustrative isometric view of the supporting member, the spacers, and the voice coil of the speaker.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

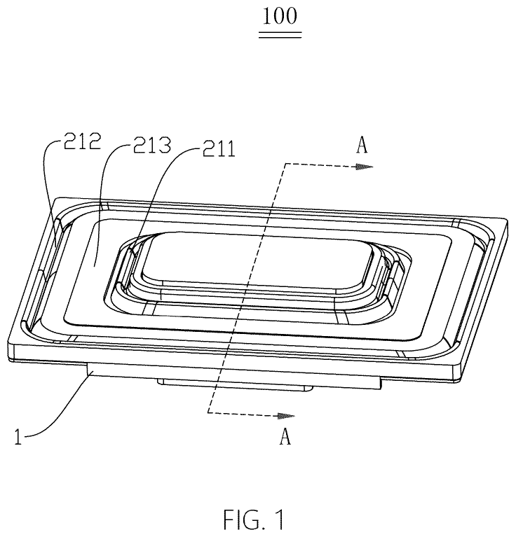

Referring to the FIGS. 1-5, the present invention provides one embodiment of a speaker 100. The speaker 100 includes a frame 1, a vibration system 2 mounted with the frame 1, and a magnetic circuit system 3 mounted with the frame 1.

The vibration system 2 includes a diaphragm 21 fixed on the frame 1, a voice coil 22 driving the diaphragm 21 to generate sounds, and a supporting member 23 connecting the diaphragm 21 and the voice coil 22. The diaphragm 21 includes a first suspension 211, a second suspension 212 arranged out of the first suspension 211, and a dome 213 located between the first suspension 211 and second suspension 212. The dome 213 includes a main portion 2131, a first extension portion 2132 bending and extending from an inner periphery of the main portion 2131 in a direction close to the supporting member 23, and a second extension portion 2133 bending and extending from the first extension portion 2132 in the direction close to the first suspension 211. An outer periphery of the main portion 2131 and the second extension portion 2133 are fixed to the supporting member 23, and the outer periphery of the first suspension 211 is fixed to the second extension portion 2133.

In the above structure, that is, the first extension portion 2132 and the second extension portion 2133 bend and extend from the main portion 2131 of the dome 213, and the outer periphery of the main portion 2131 and the second extension portion 2133 are fixed to the supporting member 23, and the outer periphery of the first suspension 211 is fixed to the second extension portion 2133, the stability of a connection between the dome 213 and the supporting member 23 can be increased, and the strength of the dome 213 can be improved. At the same time, the length of the first suspension 211 can be increased, thereby improving the reliability and acoustic performance stability of the speaker 100.

Furthermore, as shown in FIG. 4, the second extension portion 2133 includes a first surface 2133a facing to the supporting member 23 and a second surface 2133b opposite to the first surface 2133a. The first surface 2133a is fixed with the supporting member 23 by glue, and second surface 2133b is fixed with the first suspension 211 by glue.

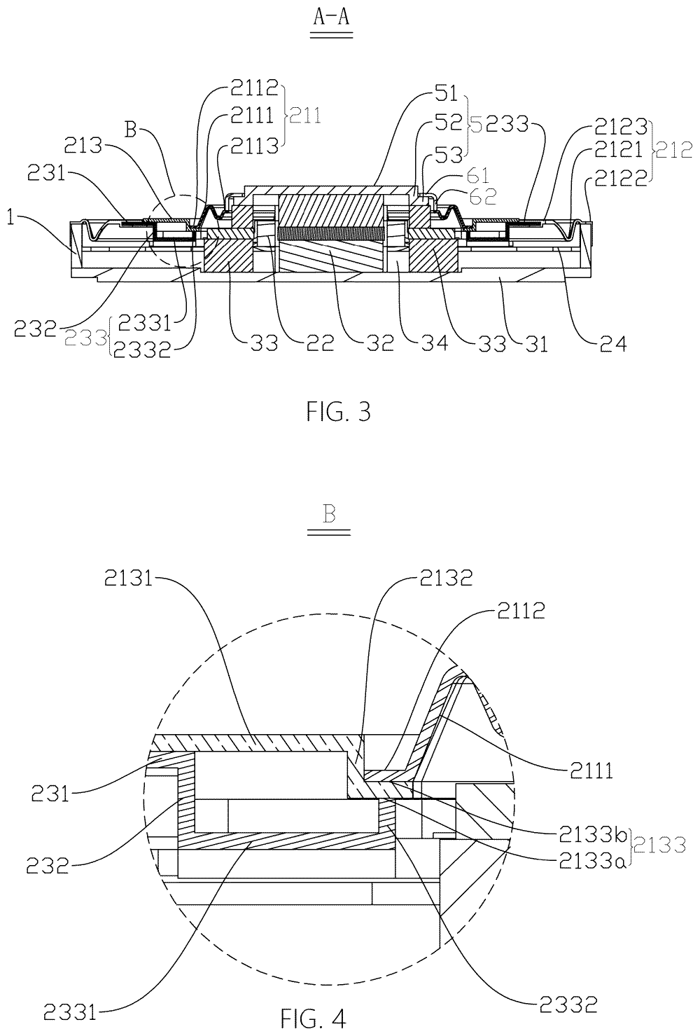

Furthermore, as shown in FIG. 3, the first suspension 211 includes a first bending portion 2111, a first outer fixing portion 2112 bending and extending from the outer periphery of the first bending portion 2111, and a first inner fixing portion 2113 bending and extending from the inner periphery of the first bending portion 2111. The first outer fixing portion 2112 is fixedly connected to the second extension portion 2133. The first outer fixing portion 2112 is closer to the supporting member 23 than the first inner fixing portion 2113 in a vibration direction of the diaphragm 21. The arrangement of the first extension portion 2132 and the second extension portion 2133 can create a height difference between the first outer fixing portion 2112 and the first inner fixing portion 2113, increase the length of the first suspension 211, and thus improve the acoustic performance of the speaker 100.

Furthermore, as shown in FIGS. 3 and 4, the supporting member 23 includes a first part 231 fixedly connected to the main portion 2131, a second part 232 bending and extending from the inner periphery of the first part 231 along the direction away from the diaphragm 21, and a third part 233 bending and extending from the second part 232 along the direction close to the first suspension 211. The third part 233 is fixedly connected to the second extension portion 2133.

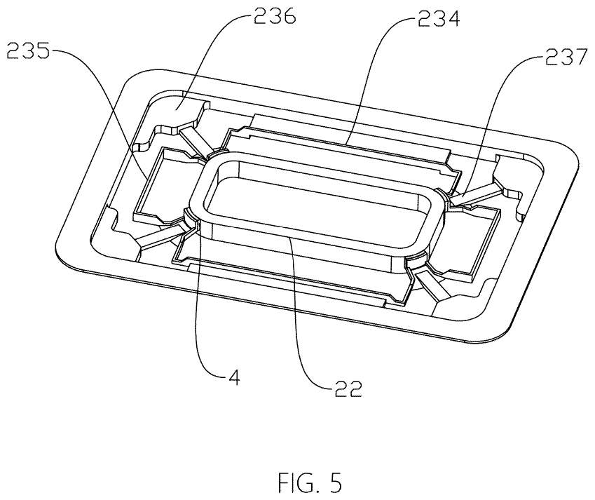

Furthermore, as shown in FIGS. 4 and 5, the third part 233 includes a first section 2331 connected to the second part 232 and a second section 2332 bending and extending from the inner periphery of the first section 2331 in the direction close to the dome 213. The second section 2332 is fixedly connected to the second extension portion 2133. The supporting member 23 includes a pair of long axis sides 234 arranged facing to each other, a pair of short axis sides 235 arranged facing to each other, and four corner portions 236 connecting the long axis sides 234 and the short axis sides 235. The supporting member 23 further includes a plurality of support portions 237 extending from each corner portion 236 in the direction close to the voice coil 22. The voice coil 22 is fixed to the support portions 237. The arrangement of the second section 2332 not only can support the dome 213 better, but also can avoid the oscillation phenomenon when the voice coil 22 brings the supporting member 23 to vibrate, and prevent the support portions 237 from torsion, and improve the stability of the supporting member 23. And at the same time, the second section 2332 cooperates with the first extension portion 2132 of the dome 213 to adjust the position of the first outer fixing portion 2112, thereby flexibly adjusting the length of the first suspension 211.

Furthermore, a plurality of spacers 4 are provided sandwiched between the support portions 237 and the voice coil 22. The arrangement of spacers 4 can prevent the damage to the wire of the voice coil 22 caused by sharp right angles or burrs on the support portions 237, which ensuring the stability of speaker 100.

Furthermore, the second suspension 212 includes a second bending portion 2121, a second outer fixing portion 2122 extending from the outer periphery of the second bending portion 2121, and a second inner fixing portion 2123 extending from the inner periphery of the second bending portion 2121. The second outer fixing portion 2122 is fixedly connected to the frame 1, and the second inner fixing portion 2123 is fixedly connected to at least one of the first part 231 and the main portion 2131. It should be noted that the fixing method of the second inner fixing portion 2123, the main portion 2131, and the first part 231 is not unique. It can be that the second inner fixing portion 2123 is fixedly connected to the main portion 2131 and then fixedly connected to the first part 231. It is also can be that the first part 231 is fixedly connected to the second inner fixing portion 2123 and the main portion 2131 at the same time, while the second inner fixing portion 2123 is not fixed to the main portion 2131, and so on, and there are no limitations here.

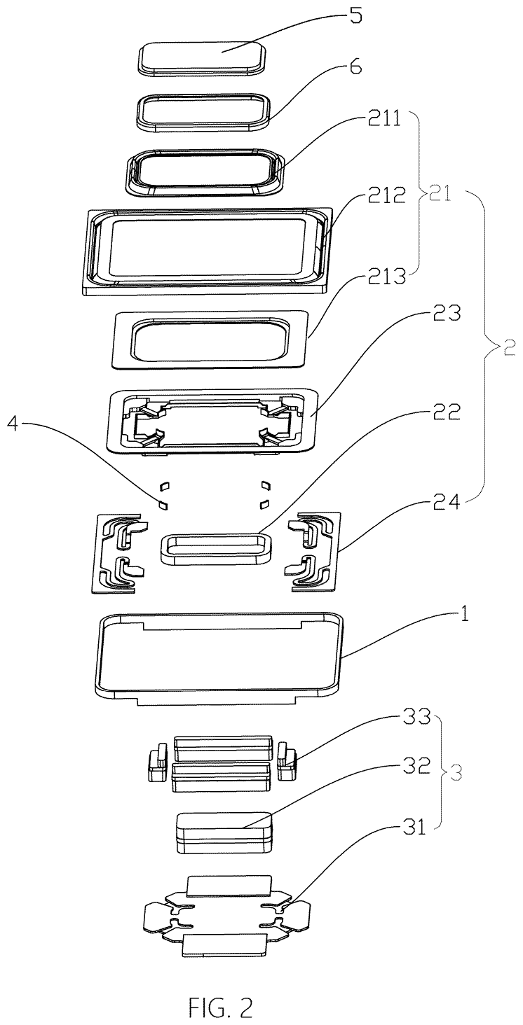

Furthermore, as shown in FIG. 2, the vibration system 2 further includes at least one flexible supporting member 24 spaced apart from the second suspension 212. The flexible supporting member 24 is fixed to the supporting member 23 and electrically connected to the voice coil 22. The number of the flexible supporting members 24 is two, and one flexible supporting member 24 is located on opposite sides of the voice coil 22. After being powered on, the voice coil 22 will drive the diaphragm 21 to vibrate and generate sounds under the action of the magnetic circuit system 3.

Furthermore, as shown in FIG. 3, the magnetic circuit system 3 includes a lower plate 31 fixed to the frame 1, a main magnetic assembly 32 fixed to an upper surface of the lower plate 31, and an auxiliary magnetic assembly 33 arranged around the main magnetic assembly 32. The main magnetic assembly 32 is spaced apart from the auxiliary magnetic assembly 33 to form a magnetic gap 34. The lower plate 31 is made of magnetic conductive material.

Furthermore, as shown in FIGS. 2-3, the speaker 100 further includes a cover portion 5 covered above the magnetic circuit system 3. The cover portion 5 includes a top wall 51, a side wall 52 extending from the top wall 51 along the direction close to the lower plate 31, and a bottom wall 53 bending and extending from the side wall 52 along the direction close to the first suspension 211 and fixed to the auxiliary magnetic assembly 33. The top wall 31 is attached to the main magnetic assembly 32.

Furthermore, the speaker 100 further includes a metal ring 6 arranged around the magnetic circuit system 3. The metal ring 6 includes a first ring portion 61 fixedly connected to the bottom wall 53 and a second ring portion 62 bending and extending from the outer periphery of the first ring portion 61 along the direction close to the first suspension 211. The second ring portion 62 is fixedly connected to the first inner fixing portion 2113. The metal ring 6 is used to fix the diaphragm 21. The metal ring 6 can make the arrangement of the vibration system 2 more flexible. By adjusting the position of the first ring portion 61, the influence of dimensional tolerances on the concentricity of the diaphragm 21 can be reduced. By flexibly adjusting the position of the first inner fixing portion 2113 through the second ring portion 62, the height difference between the first inner fixing portion 2113 and the first outer fixing portion 2112 of the first suspension 211 is prevented from being too large, thereby affecting the acoustic performance of the speaker 100.

Comparing with the related art, through the above structure, the first extension portion 2132 and the second extension portion 2133 bend and extend from the main portion 2131 of the dome 213, and the outer periphery of the main portion 2131 and the second extension portion 2133 are fixed to the supporting member 23, and the first outer fixing portion 2112 is fixed to the second extension portion 2133, which can increase the stability of the connection between the dome 213 and the supporting member 23, and improve the strength of the dome 213. At the same time, the length of the first suspension 211 can be increased, thereby improving the reliability and acoustic performance stability of the speaker 100.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker, comprising:
a frame;
a vibration system mounted with the frame, the vibration system comprising:
a diaphragm fixed on the frame, the diaphragm comprising:
a first suspension;
a second suspension arranged out of the first suspension; and
a dome located between the first suspension and second suspension;
a voice coil driving the diaphragm to generate sounds; and
a supporting member connecting the diaphragm and the voice coil; and
a magnetic circuit system mounted with the frame;
wherein the dome comprising a main portion, a first extension portion bending and extending from an inner periphery of the main portion in a direction close to the supporting member, and a second extension portion bending and extending from the first extension portion in the direction close to the first suspension, an outer periphery of the main portion and the second extension portion fixed to the supporting member, and the outer periphery of the first suspension fixed to the second extension portion.

2. The speaker as described in claim 1, wherein the second extension portion comprises a first surface facing to the supporting member and a second surface opposite to the first surface, the first surface fixed with the supporting member by glue, and second surface fixed with the first suspension by glue.

3. The speaker as described in claim 1, wherein the first suspension comprises a first bending portion, a first outer fixing portion bending and extending from the outer periphery of the first bending portion, and a first inner fixing portion bending and extending from the inner periphery of the first bending portion, the first outer fixing portion fixedly connected to the second extension portion, the first outer fixing portion closer to the supporting member than the first inner fixing portion in a vibration direction of the diaphragm.

4. The speaker as described in claim 3, wherein the supporting member comprises a first part fixedly connected to the main portion, a second part bending and extending from the inner periphery of the first part along the direction away from the diaphragm, and a third part bending and extending from the second part along the direction close to the first suspension, the third part fixedly connected to the second extension portion.

5. The speaker as described in claim 4, wherein the third part comprises a first section connected to the second part and a second section bending and extending from the inner periphery of the first section in the direction close to the dome, the second section fixedly connected to the second extension portion.

6. The speaker as described in claim 5, wherein the supporting member comprises a pair of long axis sides arranged facing to each other, a pair of short axis sides arranged facing to each other, and four corner portions connecting the long axis sides and the short axis sides, the supporting member further comprising a plurality of support portions extending from each corner portion in the direction close to the voice coil, the voice coil fixed to the support portions, a plurality of spacer provided sandwiched between the support portions and the voice coil.

7. The speaker as described in claim 4, wherein the second suspension comprises a second bending portion, a second outer fixing portion extending from the outer periphery of the second bending portion, and a second inner fixing portion extending from the inner periphery of the second bending portion, the second outer fixing portion fixedly connected to the frame, and the second inner fixing portion fixedly connected to at least one of the first part and the main portion.

8. The speaker as described in claim 7, wherein the magnetic circuit system comprises a lower plate fixed to the frame, a main magnetic assembly fixed to an upper surface of the lower plate, and an auxiliary magnetic assembly arranged around the main magnetic assembly, the main magnetic assembly spaced apart from the auxiliary magnetic assembly to form a magnetic gap.

9. The speaker as described in claim 8, wherein the speaker further comprises a cover portion covered above the magnetic circuit system, the cover portion comprising a top wall, a side wall extending from the top wall along the direction close to the lower plate, and a bottom wall bending and extending from the side wall along the direction close to the first suspension and fixed to the auxiliary magnetic assembly, the top wall attached to the main magnetic assembly.

10. The speaker as described in claim 9, wherein the speaker further comprises a metal ring arranged around the magnetic circuit system, the metal ring comprising a first ring portion fixedly connected to the bottom wall and a second ring portion bending and extending from the outer periphery of the first ring portion along the direction close to the first suspension, the second ring portion fixedly connected to the first inner fixing portion.
